(19) United States
(12) Patent Application Publication
(10) Pub. No.: US 2026/0225664 A1
(43) Pub. Date: Aug. 6, 2026

(54) LIGHTWEIGHT DASHBOARD CROSSBEAM ASSEMBLY FOR A VEHICLE

(71) Applicant: FOXTRON VEHICLE TECHNOLOGIES CO., LTD., New Taipei City (TW)

(72) Inventors: CHIA-TSANG WEN, New Taipei City (TW); LU-HAN LEE, New Taipei City (TW)

(21) Appl. No.: 19/203,196

(22) Filed: May 9, 2025

(30) Foreign Application Priority Data
Feb. 5, 2025 (TW) 114201222

(51) Int. Cl. B62D 25/14; B62D 1/16; B62D 29/00

(52) U.S. Cl. CPC B62D 25/145; B62D 1/16; B62D 29/004

(57) ABSTRACT

A lightweight dashboard crossbeam assembly for a vehicle includes a crossbeam body, an injection molding bracket, a steering column, and a screen bracket. The crossbeam body has a U-shaped structure and is made of steel. The injection molding bracket is made of plastic. The injection molding bracket includes a main connecting member and a plurality of functional connecting members, the main connecting member is disposed on the crossbeam body, and the plurality of functional connecting members are connected to the main connecting member. The steering column is made of aluminum alloy, and the steering column is disposed on the crossbeam body. The screen bracket is made of steel, and the screen bracket is disposed on the injection molding bracket.

### CROSS-REFERENCE TO RELATED PATENT APPLICATION

This application claims the benefit of priority to Taiwan Patent Application No. 114201222, filed on Feb. 5, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a vehicle dashboard crossbeam, and more particularly to a lightweight dashboard crossbeam assembly for a vehicle.

### BACKGROUND OF THE DISCLOSURE

A vehicle dashboard crossbeam is an important vehicle component. The vehicle dashboard crossbeam is installed at a front portion of a vehicle body to support a dashboard system. The structure of the vehicle dashboard crossbeam directly affects the strength and safety of a vehicle. Therefore, the vehicle dashboard crossbeam is usually made up of tubular steels and a variety of stamping brackets, and the weight of the vehicle dashboard crossbeam may exceed 10 kilograms, which is not conducive to lightweight design of the vehicle body.

Therefore, how to reduce the weight of the vehicle body while taking into account the supporting strength of the vehicle body through improvements in structural design, so as to overcome the above-mentioned problems, has become one of the important issues to be addressed in the industry.

### SUMMARY OF THE DISCLOSURE

In response to the above-referenced technical inadequacies, the present disclosure provides a lightweight dashboard crossbeam assembly for a vehicle to effectively reduce the weight of a vehicle body while maintaining the supporting strength of the vehicle body.

In order to solve the above-mentioned problems, one of the technical aspects adopted by the present disclosure is to provide a lightweight dashboard crossbeam assembly for a vehicle. The lightweight dashboard crossbeam assembly includes a crossbeam body, an injection molding bracket, a steering column, and a screen bracket. The crossbeam body has a U-shaped structure and is made of steel. The injection molding bracket is made of plastic. The injection molding bracket includes a main connecting member and a plurality of functional connecting members, the main connecting member is disposed on the crossbeam body, and the plurality of functional connecting members are connected to the main connecting member. The steering column is made of aluminum alloy. The steering column is disposed on the crossbeam body. The screen bracket is made of steel. The screen bracket is disposed on the injection molding bracket.

In one of the possible or preferred embodiments, the main connecting member of the injection molding bracket is a hollow structure.

In one of the possible or preferred embodiments, a plurality of reinforcing ribs are disposed inside the plurality of functional connecting members of the injection molding bracket.

In one of the possible or preferred embodiments, the main connecting member and the plurality of functional connecting members are integrally formed.

In one of the possible or preferred embodiments, the screen bracket has at least one strength weakening structure.

In one of the possible or preferred embodiments, the lightweight dashboard crossbeam assembly further includes a grounding bracket made of steel. The plurality of functional connecting members include a middle supporting member disposed in a middle portion of the main connecting member, and the grounding bracket is connected to the middle supporting member.

In one of the possible or preferred embodiments, a width of the middle supporting member ranges from 20 mm to 30 mm.

In one of the possible or preferred embodiments, the middle supporting member includes a first section and a second section, one end of the first section is connected to the injection molding bracket, another end of the first section is connected to one end of the second section, and another end of the second section is connected to the grounding bracket. A first angle is defined between the first section and the crossbeam body, a second angle is defined between the second section and the first section, and the first angle is smaller than the second angle.

In one of the possible or preferred embodiments, the first angle ranges from 0 degrees to 52 degrees, and the second angle ranges from 52 degrees to 137 degrees.

In one of the possible or preferred embodiments, a horizontal distance is defined between the second section and the main connecting member, and the horizontal distance ranges from 0 mm to 100 mm.

Therefore, in the lightweight dashboard crossbeam assembly for a vehicle provided by the present disclosure, by virtue of “the crossbeam body being made of steel, and the injection molding bracket being made of plastic,” “the steering column being made of aluminum alloy, and the steering column being disposed on the crossbeam body,” and “the screen bracket being made of steel, and the screen bracket being disposed on the injection molding bracket,” the lightweight dashboard crossbeam assembly can effectively reduce the weight of the vehicle body while maintaining the supporting strength of the vehicle body.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a lightweight dashboard crossbeam assembly for a vehicle according to one embodiment of the present disclosure;

FIG. 2 is a schematic exploded view of the lightweight dashboard crossbeam assembly according to one embodiment of the present disclosure;

FIG. 3 is a schematic cross-sectional view taken along line III-III of FIG. 1; and

FIG. 4 is a schematic cross-sectional view taken along line IV-IV of FIG. 1.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

Generally, a dashboard crossbeam assembly is installed in front of a driver seat of a vehicle, and is connected to a vehicle body. In practical applications, the dashboard crossbeam assembly carries a steering system, an electrical system, an air conditioning system, an airbag system, etc. Therefore, the dashboard crossbeam assembly is a crucial component of the vehicle.

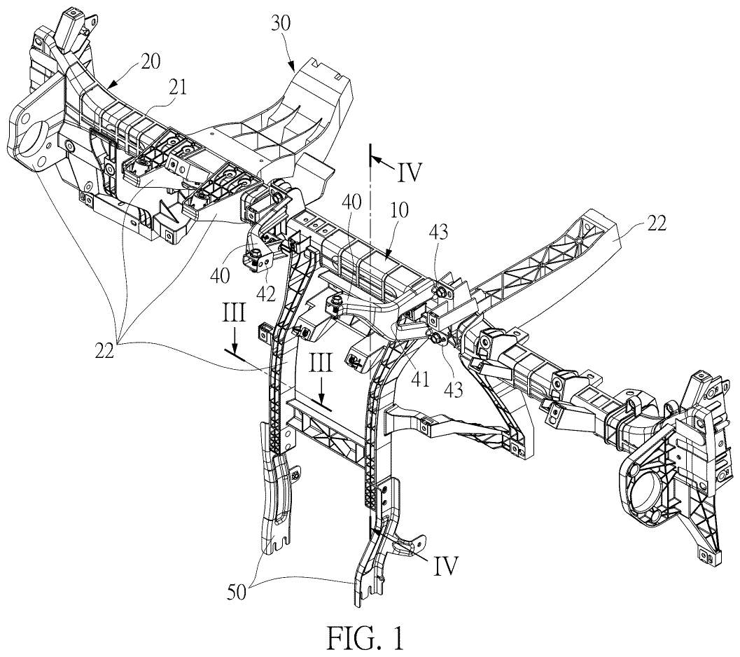

Referring to FIG. 1, the present disclosure provides a lightweight dashboard crossbeam assembly for a vehicle. The lightweight dashboard crossbeam assembly at least includes a crossbeam body 10, an injection molding bracket 20, a steering column 30, and a screen bracket 40. The crossbeam body 10 has a U-shaped structure, and the crossbeam body 10 is made of steel. The injection molding bracket 20 is made of plastic. The injection molding bracket 20 includes a main connecting member 21 and a plurality of functional connecting members 22. The main connecting member 21 is disposed on the crossbeam body 10, and the plurality of functional connecting members 22 are connected to the main connecting member 21. The steering column 30 is made of aluminum alloy, and the steering column 30 is disposed on the crossbeam body 10. The screen bracket 40 is made of steel, and the screen bracket 40 is disposed on the injection molding bracket 20. In this embodiment, the lightweight dashboard crossbeam assembly further includes a grounding bracket 50 that is made of steel.

In detail, the crossbeam body 10 is the main structure for carrying and connecting the steering system, the electrical system, the air conditioning system, and the airbag system. Therefore, the crossbeam body 10 that is made of steel has a strong supporting strength. In this embodiment, a cross-section of the crossbeam body 10 is U-shaped, and is a non-enclosed structure having an opening.

However, under normal circumstances, the dashboard crossbeam assembly is made of steel, thus increasing the weight of the vehicle body and further affecting the speed of the vehicle while traveling. Therefore, by using lighter materials (such as plastic) to produce certain components, the weight of the dashboard beam assembly can be effectively reduced, thereby reducing the weight of the vehicle body, increasing the efficiency of vehicle operation, and improving the mileage.

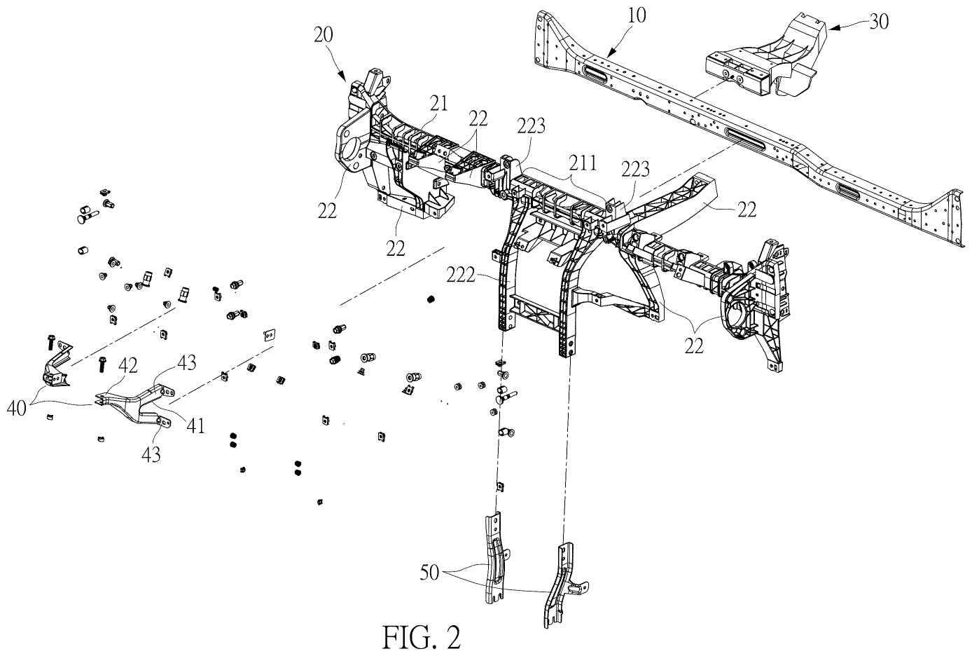

Furthermore, referring to FIG. 1 and FIG. 2, the main connecting member 21 of the injection molding bracket 20 covers a position of the crossbeam body 10 that corresponds to the opening. For example, the main connecting member 21 may be a hollow structure, so that the weight of the lightweight dashboard crossbeam assembly for a vehicle can be further reduced. In other embodiments, the hollow structure may have a circular shape, a square shape, or other irregular shapes, so as to achieve the goal of reducing the weight of the main connecting member 21.

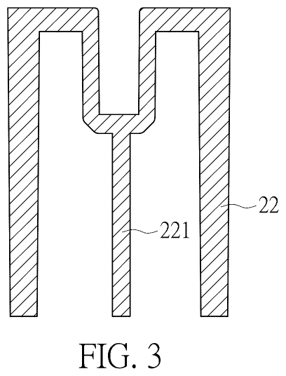

Specifically, since the material of the injection molding bracket 20 is plastic, and the plastic has a supporting strength lower than that of steel, a plurality of reinforcing ribs 221 may be disposed inside the plurality of functional connecting members 22 of the injection molding bracket 20 (as shown in FIG. 3), so as to enhance the supporting strength of the plurality of functional connecting members 22 when being connected to other components. For example, referring to FIG. 2, the plurality of functional connecting members 22 may further include a middle supporting member 222 and a screen connecting member 223. The middle supporting member 222 is disposed in a middle portion 211 of the main connecting member 21, and the grounding bracket 50 is connected to the middle supporting member 222. In this embodiment, a quantity of the screen connecting member 223 is two, and the two screen connecting members 223 are respectively located at two ends of the middle portion 211 of the main connecting member 21. In this embodiment, the main connecting member 21 and the plurality of functional connecting members 22 of the injection molding bracket 20 are integrally formed by injection molding.

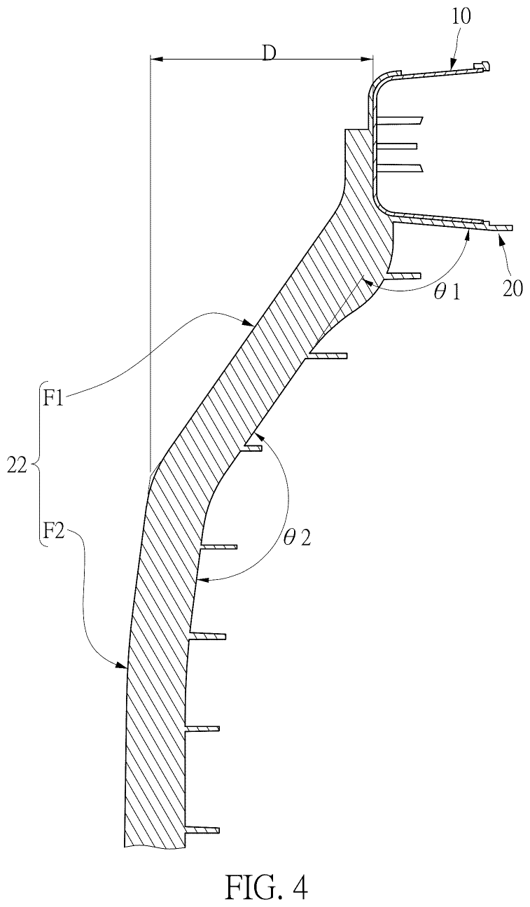

In detail, referring to FIG. 1 and FIG. 4, the middle supporting member 222 may include a first section F1 and a second section F2. One end of the first section F1 is connected to the injection molding bracket 20, another end of the first section F1 is connected to one end of the second section F2, and another end of the second section F2 is connected to the grounding bracket 50. From a cross-sectional view, a first angle θ1 is defined between the first section F1 and the crossbeam body 10, a second angle θ2 is defined between the second section F2 and the first section F1, and the first angle θ1 is smaller than the second angle θ2. For example, the first angle θ1 ranges from 0 degrees to 52 degrees, and the second angle θ2 ranges from 52 degrees to 137 degrees. In this embodiment, the first angle θ1 is 52 degrees, and the second angle θ2 is 137 degrees.

In order for the middle supporting member 222 to have a stronger supporting strength, a width of the middle supporting member 222 in the present embodiment ranges from 20 mm to 30 mm, and is preferably 25 mm.

In addition, from a cross-sectional view, a horizontal distance D is defined between the second section F2 and the main connecting member 21, and ranges from 0 mm to 100 mm (preferably 89 mm), so as to generate an avoidance angle. In this way, the vehicle can be safer.

Referring to FIG. 1 and FIG. 2, the steering column 30 is made by die casting of aluminum alloy. Therefore, by combining two different materials (heterogeneous materials), the lightweight dashboard crossbeam assembly for a vehicle can have lighter weight and greater rigidity. The steering column 30 and the crossbeam body 10 may be connected by locking or riveting, so as to achieve convenient installation. However, the present disclosure is not limited to the above-mentioned examples.

Referring to FIG. 1 and FIG. 2, the screen bracket 40 is made of steel, which can enhance the strength of fixing a screen panel. In detail, the screen bracket 40 is disposed on the screen connecting member 223 of the injection molding bracket 20. The screen bracket 40 has at least one strength weakening structure 41. In this embodiment, a quantity of the screen bracket 40 is two, and each of the screen brackets 40 further has a screen end 42 and two fixing ends 43. The screen end 42 is used to be connected with the screen panel, and the two fixing ends 43 are opposite to the screen end 42 and are used to be locked onto the screen connecting member 223 of the injection molding bracket 20. The at least one strength weakening structure 41 is located between the two fixing ends 43, such that the screen bracket 40 is Y-shaped. In practical applications, when a car is subjected to impact, the trauma caused by collision of the human head with the screen panel can be reduced through the at least one strength weakening structure 41.

The results of comparing the lightweight dashboard crossbeam assembly for a vehicle (Example) of the present disclosure with a vehicle dashboard crossbeam entirely made of steel (Comparative Example) are as shown in Table 1 below.

TABLE 1

| | Example | Comparative Example |
|---|---|---|
| Weight | 9.3 Kg | 14.4 Kg |
| Density | Steel: 7.85 g/cm³ | Steel: 7.85 g/cm³ |
| | Plastic: 1.2 g/cm³ | |
| | Aluminum alloy: 2.7 g/cm³ | |
| Precision | High | Low |
| Production | High | Low |
| yield | | |

It can be observed from the above that, compared with the vehicle dashboard crossbeam made entirely of steel, the lightweight dashboard crossbeam assembly for a vehicle provided in the present disclosure can have an improved installation precision and production yield by combining partially heterogeneous materials. Furthermore, the weight of the lightweight dashboard crossbeam assembly can be reduced by adjusting the structure of the injection molding bracket 20.

### BENEFICIAL EFFECTS OF THE EMBODIMENTS

In conclusion, in the lightweight dashboard crossbeam assembly for a vehicle provided by the present disclosure, by virtue of “the crossbeam body being made of steel, and the injection molding bracket being made of plastic,” “the steering column being made of aluminum alloy, and the steering column being disposed on the crossbeam body,” and “the screen bracket being made of steel, and the screen bracket being disposed on the injection molding bracket,” the lightweight dashboard crossbeam assembly can effectively reduce the weight of the vehicle body while maintaining the supporting strength of the vehicle body.

Furthermore, the screen bracket of the lightweight dashboard crossbeam assembly for a vehicle of the present disclosure has at least one strength weakening structure. Therefore, in a car crash, the damage caused by the human head hitting the screen panel can be reduced.

In addition, the grounding bracket of the lightweight dashboard crossbeam assembly for a vehicle is made of steel, which can enhance the supporting strength between the vehicle body and the crossbeam body. In other words, the lightweight dashboard crossbeam assembly for a vehicle provided in the present disclosure is combined by locking or riveting between partially heterogeneous materials, thereby facilitating precise installation. Moreover, the structure of the injection molding bracket can be adjusted to increase the rigidity of the injection molding bracket, so as to achieve the goal of maintaining performance and weight in a limited vehicle body space.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A lightweight dashboard crossbeam assembly for a vehicle, comprising:
a crossbeam body having a U-shaped structure and being made of steel;
an injection molding bracket made of plastic, wherein the injection molding bracket includes a main connecting member and a plurality of functional connecting members, the main connecting member is disposed on the crossbeam body, and the plurality of functional connecting members are connected to the main connecting member;
a steering column made of aluminum alloy, wherein the steering column is disposed on the crossbeam body; and
a screen bracket made of steel, wherein the screen bracket is disposed on the injection molding bracket.

2. The lightweight dashboard crossbeam assembly according to claim 1, wherein the main connecting member of the injection molding bracket is a hollow structure.

3. The lightweight dashboard crossbeam assembly according to claim 1, wherein a plurality of reinforcing ribs are disposed inside the plurality of functional connecting members of the injection molding bracket.

4. The lightweight dashboard crossbeam assembly according to claim 1, wherein the main connecting member and the plurality of functional connecting members are integrally formed.

5. The lightweight dashboard crossbeam assembly according to claim 1, wherein the screen bracket has at least one strength weakening structure.

6. The lightweight dashboard crossbeam assembly according to claim 1, further comprising a grounding bracket made of steel, wherein the plurality of functional connecting members include a middle supporting member disposed in a middle portion of the main connecting member, and the grounding bracket is connected to the middle supporting member.

7. The lightweight dashboard crossbeam assembly according to claim 6, wherein a width of the middle supporting member ranges from 20 mm to 30 mm.

8. The lightweight dashboard crossbeam assembly according to claim 6, wherein the middle supporting member includes a first section and a second section, one end of the first section is connected to the injection molding bracket, another end of the first section is connected to one end of the second section, and another end of the second section is connected to the grounding bracket; and wherein a first angle is defined between the first section and the crossbeam body, a second angle is defined between the second section and the first section, and the first angle is smaller than the second angle.

9. The lightweight dashboard crossbeam assembly according to claim 8, wherein the first angle ranges from 0 degrees to 52 degrees, and the second angle ranges from 52 degrees to 137 degrees.

10. The lightweight dashboard crossbeam assembly according to claim 8, wherein a horizontal distance is defined between the second section and the main connecting member, and the horizontal distance ranges from 0 mm to 100 mm.
